(19) United States
(12) Patent Application Publication
(10) Pub. No.: US 2017/0308193 A1
(43) Pub. Date: Oct. 26, 2017

(54) TOUCH SCREEN AND FABRICATING METHOD THEREOF, AND TOUCH DISPLAY DEVICE

(71) Applicants: BOE TECHNOLOGY GROUP CO., LTD., Beijing (CN); BOE (HEBEI) MOBILE DISPLAY TECHNOLOGY CO., LTD., Hebei (CN)

(72) Inventors: Jianjie WU, Beijing (CN); Lili CHEN, Beijing (CN); Ruijun DONG, Beijing (CN); Chenru WANG, Beijing (CN); Guangquan WANG, Beijing (CN); Haiwei SUN, Beijing (CN)

(73) Assignees: BOE TECHNOLOGY GROUP CO., LTD., Beijing (CN); BOE (HEBEI) MOBILE DISPLAY TECHNOLOGY CO., LTD., Gu'an, Hebei (CN)

(21) Appl. No.: 15/511,320

(22) PCT Filed: Apr. 6, 2016
(86) PCT No.: PCT/CN2016/078570

§ 371 Date: Mar. 15, 2017

(30) Foreign Application Priority Data
Jun. 30, 2015 (CN) 201510375133.1

(51) Int. Cl. G06F 3/041

(52) U.S. Cl. CPC G06F 3/041; G06F 2203/04103

(57) ABSTRACT

The embodiments of the present disclosure provide a touch screen and a fabricating method thereof, and a touch display device. The touch screen includes a touch sensor, a polymer film provided on the touch sensor, a λ/4 wave plate provided on the polymer film, and configured to cause a phase delay of light incident therein, so as to change a polarization state of the light, and a polarization film provided on the λ/4 wave plate, and configured to polarize light incident therein to generate polarized light.

### CROSS REFERENCE TO RELATED APPLICATIONS

This application is a National Stage Entry of PCT/CN2016/078570 filed Apr. 6, 2016, which claims the benefit and priority of Chinese Patent Application No. 201510375133.1, filed on Jun. 30, 2015, the disclosures of which are incorporated by reference herein in their entirety as a part of the present application.

### BACKGROUND

The embodiments of the present disclosure relate to the field of display technologies, and particularly, to a touch screen and a fabricating method thereof, and a touch display device.

This section provides background information related to the embodiments of the present application which is not necessarily prior art.

Due to the structure and material of the touch screen product of the display device such as cellular phone, the touch screen with a reflection effect will reflect strong reflected light into the user's eyes when it is used under strong light such as sunlight. As a result, the user cannot clearly see information displayed on the touch screen. Meanwhile, the reflection of light into the user's eyes will easily damage the user's eyes.

For this reason, in order for anti-reflection, currently in the market the anti-reflection film is usually used, and it needs to be bonded onto the touch screen of the display device such as cellular phone. The anti-reflection film achieves an anti-reflection effect to some extent. However, since it is bonded later, the light transmittance of the screen is badly affected so that the screen becomes dark and the touch sensitivity decreases. In addition, the requirement of the bonding technology is high, so an improper bonding will easily cause defects such as bubbles and falling off, which impair the appearance. Moreover, the thickness and cost of the display module are also increased.

### BRIEF DESCRIPTION

This section provides a general summary of the embodiments of the present disclosure, and is not a comprehensive disclosure of its full scope or all of its features.

The embodiments of the present disclosure provide a touch screen and a fabricating method thereof, and a touch display device, which at least partially alleviate the problem that the user cannot clearly see information displayed on the touch screen due to a reflection of light by the touch screen when it is used under strong light.

A first aspect of the embodiments of the present disclosure provides a touch screen including a touch sensor, a polymer film provided on the touch sensor, a λ/4 wave plate provided on the polymer film and configured to cause a phase delay of light incident therein, so as to change a polarization state of the light, and a polarization film provided on the λ/4 wave plate and configured to polarize light incident therein to generate polarized light.

In one embodiment, the touch sensor, the polymer film, the λ/4 wave plate, and the polarization film are sequentially bonded together through an optical adhesive.

In one embodiment, the touch screen further includes a protection film provided on a surface of the polarization film.

In one embodiment, the touch screen further includes a transflective metal shielding film provided between the λ/4 wave plate and the polymer film.

In one embodiment, the optical adhesive for bonding the polarization film with the λ/4 wave plate is an acidiferous optical adhesive.

In one embodiment, the transflective metal shielding film is provided between the λ/4 wave plate and the polymer film through the optical adhesive, and the optical adhesive for bonding the λ/4 wave plate with the transflective metal shielding film, the transflective metal shielding film with the polymer film, and the polymer film with the touch sensor is a non-acidiferous optical adhesive containing antistatic particles.

In one embodiment, the optical adhesive is an optical pressure sensitive adhesive.

In one embodiment, the touch sensor is a flexible touch sensor.

In one embodiment, the touch sensor is fabricated with one or more of conductive glass, fluorine-doped tin oxide, carbon nanotube, nano-silver, grapheme, and high molecular material.

In one embodiment, the polarization film, the λ/4 wave plate, the transflective metal shielding film, the polymer film, and the touch sensor are sequentially bonded in a form of full lamination or a form of frame lamination.

A second aspect of the embodiments of the present disclosure provides a fabricating method of a touch screen including forming a polymer film on a touch sensor, forming a λ/4 wave plate on the polymer film, and forming a polarization film on the λ/4 wave plate, wherein the polarization film is configured to polarize light incident therein to generate polarized light, and the λ/4 wave plate is configured to cause a phase delay of the polarized light incident therein, so as to change a polarization state of the polarized light.

In one embodiment, forming the polymer film on the touch sensor includes bonding the polymer film on the touch sensor through an optical adhesive, forming the λ/4 wave plate on the polymer film includes bonding the λ/4 wave plate on the polymer film through an optical adhesive, and forming the polarization film on the λ/4 wave plate includes bonding the polarization film on the λ/4 wave plate through an optical adhesive.

In one embodiment, the method further includes forming a protection film on a surface of the polarization film, wherein the protection film is used for anti-dazzle, anti-reflection and/or anti-static electricity.

In one embodiment, forming the λ/4 wave plate on the polymer film includes forming a transflective metal shielding film on the polymer film, and forming the λ/4 wave plate on the transflective metal shielding film.

In one embodiment, the transflective metal shielding film is bonded on the polymer film through an optical adhesive, and the λ/4 wave plate is bonded on the polymer film through an optical adhesive.

In one embodiment, the optical adhesive for bonding the polarization film with the λ/4 wave plate is an acidiferous optical adhesive, the optical adhesive for bonding the λ/4 wave plate with the transflective metal shielding film, the transflective metal shielding film with the polymer film, and the polymer film with the touch sensor is a non-acidiferous optical adhesive containing antistatic particles.

In one embodiment, the optical adhesive is an optical pressure sensitive adhesive.

In one embodiment, the touch sensor is a flexible touch sensor.

In one embodiment, the touch sensor is fabricated with one or more of conductive glass, fluorine-doped tin oxide, carbon nanotube, nano-silver, grapheme, and high molecular material.

In one embodiment, the polarization film, the λ/4 wave plate, the transflective metal shielding film, the polymer film and the touch sensor are sequentially bonded in a form of full lamination or a form of frame lamination.

A third aspect of the embodiments of the present disclosure provides a touch display device including a display screen and any of the aforementioned touch screens, wherein the touch screen is attached on the display screen.

According to the touch screen and the fabricating method thereof and the touch display device provided by the embodiments of the present disclosure, a polarization film and a λ/4 film are used to change the light path of the ambient light, which reduces the emergence of light, which is reflected by the touch screen, from the surface of the touch screen, thereby reducing the influence of the ambient light on the display effect of the display module, increasing the contrast ratio, improving the viewing effect of human eyes, and achieving the anti-reflection function of the touch screen. In addition, the embodiments of the present disclosure adopt an integrated design of the touch screen and the polarizer, so the structure is simple, the production process is mature, and the light transmittance and the touch sensitivity will not be influenced. In addition, the flexible material may be used in conjunction with the AMOLED display screen to fabricate a flexible touch display.

Further aspects and areas of applicability will become apparent from the description provided herein. It should be understood that various aspects of this application may be implemented individually or in combination with one or more other aspects. It should also be understood that the description and specific examples herein are intended for purposes of illustration only and are not intended to limit the scope of the present application.

### BRIEF DESCRIPTION OF THE DRAWINGS

The drawings described herein are for illustrative purposes only of selected embodiments and not all possible implementations, and are not intended to limit the scope of the present application.

FIG. 1 shows a schematic diagram of a structure of a touch screen according to Embodiment 1 of the present disclosure;

FIG. 2 shows a schematic diagram of a reflected light path of a touch screen according to Embodiment 1 of the present disclosure;

FIG. 3 shows a schematic diagram of a structure of a fully-bonded touch screen according to Embodiment 2 of the present disclosure;

FIG. 4 shows a schematic diagram of the anti-reflection principle of a fully-laminated touch screen according to Embodiment 2 of the present disclosure;

FIG. 5 shows a schematic diagram of a structure of a frame-laminated touch screen according to Embodiment 2 of the present disclosure;

FIG. 6 shows a schematic diagram of the principle of anti-reflection of a frame-bonded touch screen according to Embodiment 2 of the present disclosure;

FIG. 7 shows a schematic flowchart of a fabricating method of a touch screen according to Embodiment 4 of the present disclosure; and

FIG. 8 shows a schematic diagram of a structure of a touch display device according to Embodiment 3 of the present disclosure.

Corresponding reference numerals indicate corresponding parts or features throughout the several views of the drawings.

### DETAILED DESCRIPTION

Exemplary embodiments will now be described more fully with reference to the accompanying drawings.

### Embodiment 1

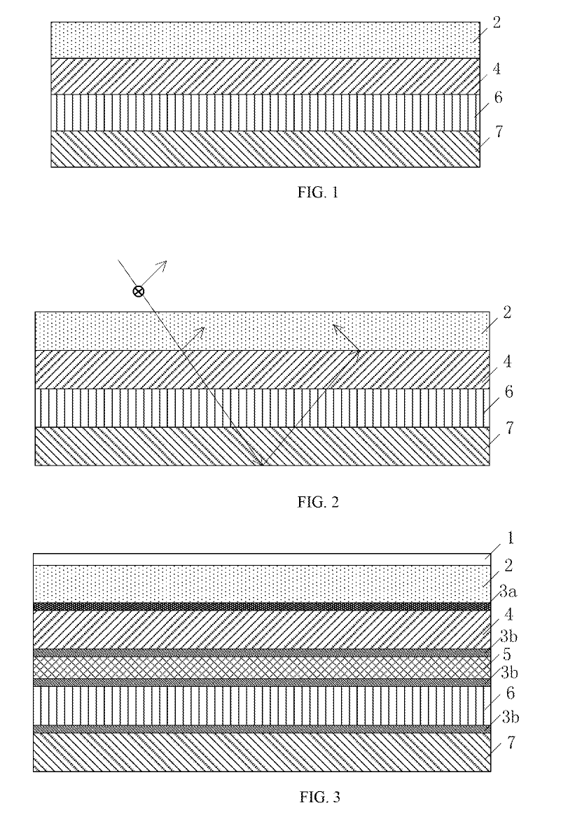

Embodiment 1 of the present disclosure provides a touch screen, as illustrated in FIG. 1, including a polarization film 2, a λ/4 wave plate 4, a polymer film 6, and a touch sensor 7, wherein the polarization film 2 is configured to polarize ambient light incident therein to generate polarized light, and the λ/4 wave plate 4 is configured to cause a λ/4 phase delay of incident light, wherein the λ is a wavelength of the incident light.

In the embodiment, by combining the polarization film 2 with the λ/4 wave plate (phase difference film) 4, it is helpful to reduce the reflection of the ambient light and thus improve the use effect.

FIG. 2 is a schematic view of a reflected light path of a touch screen according to Embodiment 1 of the present disclosure. Natural light (it is circularly polarized light and indicated by two polarization components perpendicular to each other in FIG. 2) incident to the polarization film forms polarized light after passing through the polarization film. The polarized light is incident to the λ/4 wave plate, emergent from a lower surface of the λ/4 wave plate to generate a λ/4 phase delay, and reflected by a film layer below the λ/4 wave plate to hit the λ/4 wave plate again, then it generates a λ/4 phase delay again when being emergent from an upper surface of the λ/4 wave plate. Thus totally a λ/4 phase delay is generated between the polarized light (reflected light) emergent from the upper surface of the λ/4 wave plate and the polarized light incident thereto. The polarization directions of the two polarized light beams are perpendicular to each other, and the reflected light cannot pass through the polarizer, thus the reflected light is prevented from entering the user's eyes.

The polarization film 2 may be a Polyvinyl Alcohol (PVA) polarization film made of a PVA film layer by dyeing and stretching. The polarization film 2 is the main part forming the polarized light. By stretching the polyvinyl alcohol film, iodine molecules embedded therein are oriented to have dichroism, so as to absorb a light component in the polarization direction the same as that in the stretching direction, and transmit a light component which is perpendicular to the stretching direction. The λ/4 wave plate 4 may be one of cyclic olefin polymer, polycarbonate film and cellulose triacetate film, which is configured to cause a λ/4 phase delay of the incident light, so that the reflected light and the incident light offsets each other due to the phase delay.

The polarization film 2, the λ/4 wave plate 4, the polymer (PET) film 6, and the touch sensor 7 may be orderly bonded through an optical adhesive. Specifically, the optical adhesive may be applied between the polarization film 2 and the λ/4 wave plate 4, between the λ/4 wave plate 4 and the polymer film 6, and between the polymer film 6 and the sensor 7, so as to form an integrated anti-reflection touch screen, reduce the thickness of the display module, and facilitate the fabrication of the ultra-thin module display screen.

### Embodiment 2

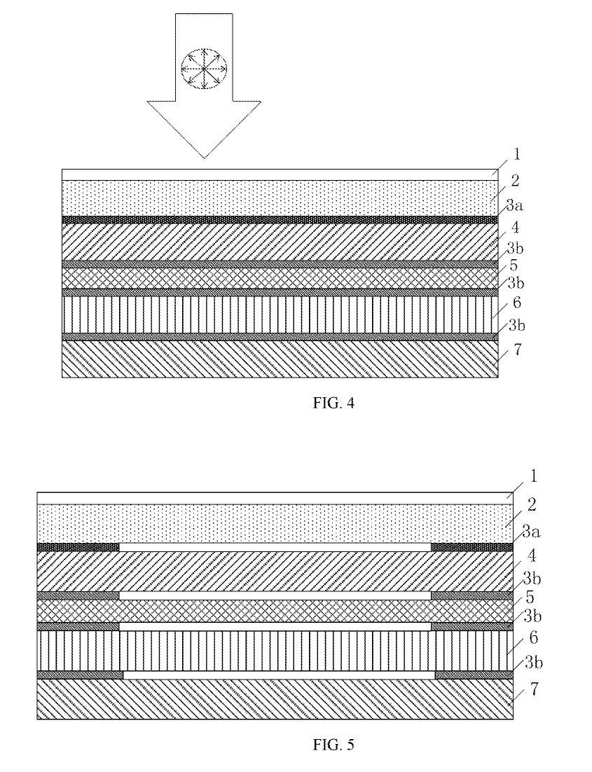

Embodiment 2 of the present disclosure provides another type of touch screen as illustrated in FIG. 3. On the basis of the touch screen as described in Embodiment 1 of the present disclosure, a protection film 1 may be further provided on the surface of the polarization film 2 to prevent dazzle, reflection and/or static electricity. The protection film 1 may be an antireflective cellulose triacetate protection film which isolates moisture and air using a TAC film layer with optical homogeneity and good transparency, so as to prevent the polarization film 2 from losing the polarizing properties due to color fading caused by water absorption. Meanwhile, the protection film 1 may be performed processing such as anti-dazzle, anti-reflection, anti-ultraviolet and/or antistatic electricity coating, to form a functional protection film.

In one embodiment, a transflective metal shielding film 5 may be further provided between the λ/4 wave plate 4 and the polymer film 6. For example, the transflective metal shielding film 5 may be provided between the λ/4 wave plate 4 and the polymer film 6 though an optical adhesive. The transflective metal shielding film 5 may be a gold-plated film, a silver-plated film, an aluminum-plated film or other transflective metal film. In this embodiment, by providing the transflective metal shielding film 5 between the λ/4 wave plate 4 and the polymer film 6, the interference may be reduced and the touch sensitivity of the touch screen may be improved.

In this embodiment, the optical adhesive used between layers of the touch screen may be an optical pressure sensitive adhesive. The polymeric monomers used to fabricate the pressure sensitive adhesive include viscous monomers, interpolymers and modified monomers. In one example, the optical pressure sensitive adhesive used for the polarizer may be a polyacrylate solvent pressure sensitive adhesive. As the acidiferous optical pressure sensitive adhesive has a high degree of adhesion, the non-acidiferous optical pressure sensitive adhesive may be well bonded with metals. Meanwhile, antistatic particles may be added into the optical adhesive to reduce the interference and improve the sensitivity of the touch screen. Thus in the embodiment of the present disclosure, the acidiferous optical adhesive 3a may be used between the polarization film 2 and the λ/4 wave plate 4, while a non-acidiferous optical adhesive 3b containing antistatic particles may be used between the λ/4 wave plate 4, the transflective metal shielding film 5, the polymer film 6, and the touch sensor 7.

In one embodiment, the touch sensor 7 may be a flexible touch sensor for use in fabricating a flexible touch screen. The touch sensor 7 may be fabricated with one or more of conductive glass (ITO), fluorine-doped tin oxide (FTO), carbon nanotube, nano silver, grapheme, and high molecular material. For example, the flexible touch sensor may be fabricated with the carbon nanotube, or the combination of the carbon nanotube and the high molecular material, so as to achieve good touch functionality using the anisotropic conductivity of these materials, while realizing a flexible touch.

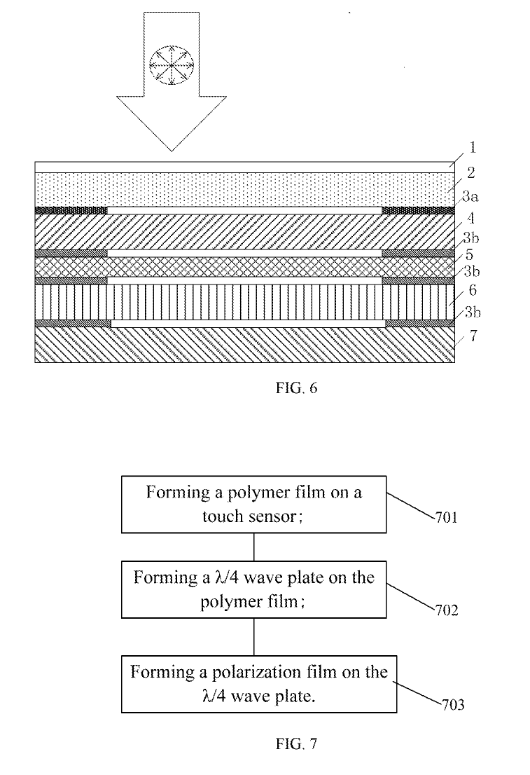

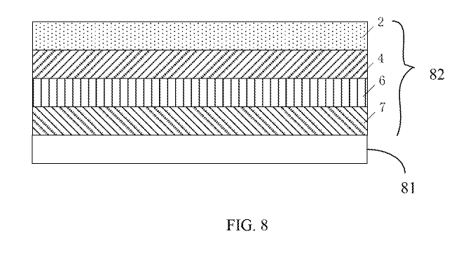

Optionally, the laminating manner between the respective film layers or parts in the touch screen may be in the form of full lamination or frame lamination or a combination thereof. In which, FIG. 3 shows a schematic diagram of a structure of a touch screen fabricated in the form of full lamination, and FIG. 4 shows a schematic diagram of the anti-reflection principle of a touch screen fabricated in the form of full lamination. As can be seen from FIG. 4, the reflected light obtained after natural light incident to the touch screen passes through individual film layers cannot be emergent from the polarization film, thereby achieving an anti-reflection effect. FIG. 5 shows a schematic diagram of a structure of a touch screen fabricated in the form frame lamination, and FIG. 6 shows a schematic diagram of the anti-reflection principle of a touch screen fabricated by frame bonding. Being similar to FIG. 4, the reflected light obtained after natural light incident to the touch screen passes through individual film layers cannot be emergent from the polarization film, thereby achieving an anti-reflection effect. In the embodiment, when the full lamination is adopted, the mechanical strength of the touch screen may be increased; while when the frame lamination is adopted, for a high contrast display screen of the Active Matrix Organic Light-Emitting Diode (AMOLED), a light attenuation process may be performed through the reflection of air to reduce the fabricating cost of the polarizer.

### Embodiment 3

As illustrated in FIG. 3, Embodiment 3 of the present disclosure provides a touch display device including a display screen 81, and a touch screen 82 according to any of the above embodiments, wherein the touch screen is bonded onto the display screen.

In one embodiment, the display screen may be an AMOLED display module.

### Embodiment 4

Embodiment 4 of the present disclosure provides a fabricating method of a touch screen. As illustrated in FIG. 7, the fabricating method includes the steps of:

S701: forming a polymer film on a touch sensor. In this embodiment, the polymer film may be bonded to the touch sensor through an optical adhesive (e.g., a non-acidiferous optical adhesive containing antistatic particles);

S702: forming a λ/4 wave plate on the polymer film. In this embodiment, the λ/4 wave plate may be bonded to the polymer film through an optical adhesive (e.g., a non-acidiferous optical adhesive containing antistatic particles);

S703: forming a polarization film on the λ/4 wave plate, wherein the polarization film is configured to polarize light incident therein to generate polarized light, and the λ/4 wave plate is configured to cause a phase delay of the polarized light incident therein to change a polarization state of the polarized light. In this embodiment, the polarization film may be bonded to the λ/4 wave plate through an optical adhesive (e.g., an acidiferous optical adhesive).

As mentioned above, the touch sensor, the polymer film, the λ/4 wave plate and the polarization film may be sequentially bonded together through the optical adhesive, and the optical characteristics of the λ/4 wave plate and the polarization film may be adopted to change the polarization state of the ambient light incident to the touch screen, so as to prevent the ambient light from being reflected into the user's eyes and making the user be unable to clearly see information displayed on the touch screen.

In one embodiment, the fabricating method of the touch screen may further include bonding a protection film onto a surface of the polarization film using the optical adhesive. The protection film may be used for anti-dazzle, anti-reflection and/or anti-static electricity.

In one embodiment, the λ/4 wave plate may be formed on the polymer film in the following method: firstly, a transflective metal shielding film may be formed on the polymer film for reducing the interference and improving the touch sensitivity of the touch screen, next, the λ/4 wave plate may be formed on the transflective metal shielding film.

In one embodiment, the optical adhesive used may be an optical pressure sensitive adhesive.

In one embodiment, the touch sensor may be a flexible touch sensor.

In one embodiment, the touch sensor may be fabricated with one or more of conductive glass, fluorine-doped tin oxide, carbon nanotube, nano silver, grapheme, and high molecular material.

In one embodiment, the touch screen may be fabricated by full lamination or frame lamination.

According to the touch screen and the fabricating method thereof and the touch display device provided by the embodiments of the present disclosure, a polarization film, and a λ/4 film are used to change the light path of the ambient light, which reduces the emergence of light reflected by the touch screen from the surface of the touch screen, thereby reducing the influence of the ambient light on the display effect of the display module, increasing the contrast ratio, improving the viewing effect of human eyes, and achieving the anti-reflection functionality of the touch screen. In addition, the touch screen and the polarizer are designed as an integration form in the embodiments of the present disclosure, so the structure is simple, the production process is mature, and the light transmittance and the touch sensitivity will not be influenced. In addition, the flexible material may be used in conjunction with the AMOLED display screen to fabricate a touchable flexible display.

To be pointed out, when the elements and the embodiments of the present disclosure are introduced, the articles “a”, “an”, “the” and “said” are intended to represent the existence of one or more elements.

In addition, the expressions “have”, “comprise”, “include” and their grammatical varieties are used in a non-exclusive manner. Thus the expressions “A has B”, “A comprises B” and “A includes B” all indicate a fact that besides B, A further includes one or more additional components and/or constitute elements and a condition that besides B, any other component, constitute element or member is not presented in A.

It shall also be understood that when an element or layer is referred to as being “on” or “above” another element or layer, it may be directly located on other element, or there may be an intermediate layer, when an element or layer is referred to as being “under” or “below” another element or layer, it may be directly located under other element, or there may be more than one intermediate layer or element, and when an element or layer is referred to as being “between” two layers or elements, it may be an unique layer between the two layers or elements, or there may be more than one intermediate layer or element.

The foregoing description of the embodiment has been provided for purpose of illustration and description. It is not intended to be exhaustive or to limit the application. Individual elements or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the application, and all such modifications are included within the scope of the application.

1. A touch screen comprising:
a touch sensor;
a polymer film provided on the touch sensor;
a λ/4 wave plate provided on the polymer film, and configured to cause a phase delay of light incident therein, so as to change a polarization state of the light; and
a polarization film provided on the λ/4 wave plate, and configured to polarize light incident therein to generate polarized light.

2. The touch screen according to claim 1, wherein the touch sensor, the polymer film, the λ/4 wave plate, and the polarization film are sequentially bonded together using an optical adhesive.

3. The touch screen according to claim 1 further comprising a protection film provided on a surface of the polarization film.

4. The touch screen according to claim 2 further comprising a transflective metal shielding film provided between the λ/4 wave plate and the polymer film.

5. The touch screen according to claim 2, wherein the optical adhesive for bonding the polarization film with the λ/4 wave plate is an acidiferous optical adhesive.

6. The touch screen according to claim 4, wherein the transflective metal shielding film is provided between the λ/4 wave plate and the polymer film through the optical adhesive, and wherein the optical adhesive for bonding the λ/4 wave plate with the transflective metal shielding film, the transflective metal shielding film with the polymer film, and the polymer film with the touch sensor is a non-acidiferous optical adhesive containing antistatic particles.

7. The touch screen according to claim 2, wherein the optical adhesive is an optical pressure sensitive adhesive.

8. The touch screen according to claim 1, wherein the touch sensor is a flexible touch sensor.

9. The touch screen according to claim 1, wherein the touch sensor is fabricated with at least one of conductive glass, fluorine-doped tin oxide, carbon nanotube, nano silver, grapheme, and high molecular material.

10. The touch screen according to claim 4, wherein the polarization film, the λ/4 wave plate, the transflective metal shielding film, the polymer film, and the touch sensor are sequentially bonded in one of a form of full lamination and a form of frame lamination.

11. A fabricating method of a touch screen comprising:
forming a polymer film on a touch sensor;
forming a λ/4 wave plate on the polymer film; and
forming a polarization film on the λ/4 wave plate, wherein the polarization film is configured to polarize light incident therein to generate polarized light, and wherein the λ/4 wave plate is configured to cause a phase delay of the polarized light incident therein, so as to change a polarization state of the polarized light.

12. The fabricating method according to claim 11, wherein:
forming the polymer film on the touch sensor comprises bonding the polymer film on the touch sensor through an optical adhesive;
forming the λ/4 wave plate on the polymer film comprises bonding the λ/4 wave plate on the polymer film through an optical adhesive; and
forming the polarization film on the λ/4 wave plate comprises bonding the polarization film on the λ/4 wave plate using an optical adhesive.

13. The fabricating method according to claim 11 further forming a protection film on a surface of the polarization film.

14. The fabricating method according to claim 12, wherein forming the λ/4 wave plate on the polymer film comprises:
forming a transflective metal shielding film on the polymer film; and
forming the λ/4 wave plate on the transflective metal shielding film.

15. The fabricating method according to claim 14, wherein the transflective metal shielding film is bonded on the polymer film using an optical adhesive, and wherein the λ/4 wave plate is bonded on the polymer film using an optical adhesive.

16. (canceled)

17. (canceled)

18. (canceled)

19. The fabricating method according to claim 11, wherein the touch sensor is fabricated with at least one of conductive glass, fluorine-doped tin oxide, carbon nanotube, nano silver, grapheme, and high molecular material.

20. The fabricating method according to claim 14, wherein the polarization film, the λ/4 wave plate, the transflective metal shielding film, the polymer film, and the touch sensor are sequentially bonded in one of a form of full lamination and a form of frame lamination.

21. A touch display device comprising a display screen and a touch screen, wherein the touch screen is bonded on the display screen, wherein the touch screen comprises:
a touch sensor;
a polymer film provided on the touch sensor;
a λ/4 wave plate provided on the polymer film, and configured to cause a phase delay of light incident therein, so as to change a polarization state of the light; and
a polarization film provided on the λ/4 wave plate, and configured to polarize light incident therein to generate polarized light.

22. The touch display device according to claim 21 further comprising a protection film provided on a surface of the polarization film.

23. The touch display device according to claim 21 further comprising a transflective metal shielding film provided between the λ/4 wave plate and the polymer film.
